(19) United States
(12) Patent Application Publication
(10) Pub. No.: US 2018/0139688 A1
(43) Pub. Date: May 17, 2018

(54) CELL PHONE DEVICE BLOCKING SYSTEM WHEN USED IN MOTOR VEHICLES OF ANY KIND

(71) Applicants: JEFFERSON CESAR DA SILVA, CURITIBA (BR); SIMONE DO NASCIMENTO ALVES, CURITIBA (BR)

(72) Inventors: JEFFERSON CESAR DA SILVA, CURITIBA (BR); SIMONE DO NASCIMENTO ALVES, CURITIBA (BR)

(21) Appl. No.: 15/327,653

(22) PCT Filed: Aug. 25, 2015
(86) PCT No.: PCT/BR2015/050129

§ 371 Date: Jan. 19, 2017

(30) Foreign Application Priority Data
Jul. 28, 2015 (BR) PI 102015017928-6

(51) Int. Cl. H04W 48/04; H04M 3/42

(52) U.S. Cl. CPC H04W 48/04; H04M 2242/30; H04M 3/42348

(57) ABSTRACT

2) The present patent invention (1) is intended for the field of road safety, more specifically for the area of prevention of traffic accidents inhibiting the use of the cell phone device, to make or receive cell phone calls, thereby preventing the driver from being neglected and causing an accident, wherein it is constituted by an electro electronic device provided with sensors and other components which will create an electromagnetic isolation into the vehicle interior, more specifically in the cabin, which will isolate either the emitted signals (4) or the received signals (5) by the cell phone device (6) it is also noteworthy that when in operation, in case the driver presses or activates the call receipt key, the sensors installed on the device will trigger specific components which will create an electromagnetic isolation (2), increasing the signal-to-noise ratio when capturing by means of the sensors the beginning of the use of the cell phone device (6), whenever the motor vehicle (3) is in motion or is turned on, avoiding, this way, making cell phone calls, as well as receiving them. That is, when the motor vehicle is stopped and turned off, the cell phone device can be used normally.

### 1.'INTRODUCTION

The present patent invention description relates to a cell phone device blocking system when used in motor vehicles of any kind wherein the cell phone device blocking system avoids the making and receiving of calls on cell phone devices, especially when the driver of the motor vehicle is the one who makes or receives the referred calls.

### 2.—APPLICATION FIELD

The scope of this cell phone device blocking system when used in motor vehicles of any kind, as its own title indicates, concerns the Field of Road safety, specifically the area of prevention of traffic accidents.

### 3.—PURPOSES

The main purposes of this cell phone device blocking system when used in motor vehicles of any kind, as stated on the above mentioned paragraph is the prevention of traffic accidents, since the use of the system inhibits the use of the cell phone device, whether making or receiving calls when the motor vehicle is in motion or when it is turned on. That is, when the motor vehicle is stopped and turned off, the cell phone device can be used normally, thereby preventing the driver from being neglected and causing an accident.

### 4.—PRIOR ART

Currently there are several kinds of cell phone signal blockers, which are devices that have the ability to prevent that certain region or area be able to receive or make any connection through the mobile telephony system, highlighting that up to the present moment nothing has been developed in order to block the signal of cell phone devices when being used inside a motor vehicle.

In order to perform blocking of a cell phone device, it is necessary to know two basic operating principles, the first one concerns the exchange of messages between the central and the cell phone device and the second, the relation between the received signal and the ambient noise where the phone is located.

Thus, in order to make a phone call, one must dial a number and then press the SEND key. By doing that, the phone places this number into a message, does the modulation at a specific frequency and transmits the signal to the nearest mobile station unit closer to the cell phone device. In order to accomplish with the necessary connections and be capable of completing a cell phone call, the station must receive the signal sent, be able to demodulate the message and “read or understand” the number which the referred cell phone intends to call

In order to receive a cell phone call, it is necessary that the cell phone system recognizes which is the nearest mobile station closer to the cell phone device. For this, all cell phone devices are tuning into a specific channel, sent by all system stations, which contains the information of the calls. All terminals receive information related to all system calls, but are only able to read the ones directed to their respective cell phone devices, due to the different serial numbers of each phone or cell phone device.

Even for a connection to the internet, service which some digital networks allow doing, it is also necessary to exchange messages. Data, voice and messages transmissions are made at different frequencies to the mobile station and to the cell phone device, leaving a spacing that avoids interference.

For decoding the messages which are modulated, the cell phone and the mobile station must receive a minimum signal level, that when it is compared to the ambient noise, it provides a minimum signal relation by noise ratio. The noise is the sum of all RF signals present at that frequency. If the signal-to-noise ratio is too bad, even if the station or the cell phone device increase their transmission power, it will not be possible to “hear” the messages exchanged, namely demodulate all information exchanged. Making it clear: if the noise level is too large, it will not be possible to establish communication between the station and the cell phone terminal, even though both transmit at high power.

### 5.—TECHNOLOGICAL ADVANCEMENT

The technological advancement offered by this cell phone blocking system when used in motor vehicles of any kind consists of the development of the technical elements required to increase the signal-to-noise ratio when capturing by means of sensors the beginning of the use of a cell phone device, when the motor vehicle is in motion or when it is turned on, thus it will avoid making as well as receiving cell phone calls. That is, when the motor vehicle is stopped and turned off, the cell phone device can be used normally.

### 6.—DESCRIPTION OF THE DRAWINGS

In order to obtain an utter and complete view of how this Cell phone device blocking system when used in motor vehicles of any kind, object of the present patent invention application, is constituted, it is attached herewith an illustrative figure, to which reference is made as follows:

FIG. 1: It represents the schematic view of the Cell phone device blocking system when used in motor vehicles of any kind.

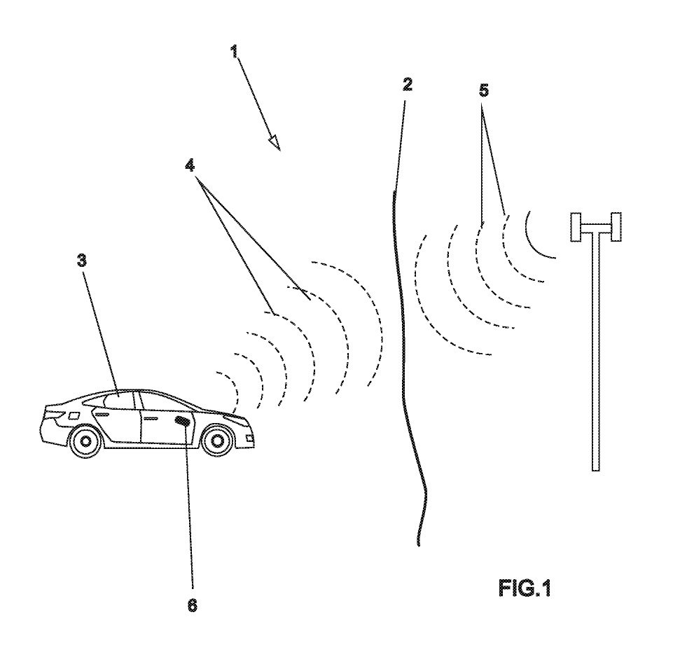

### 7.—DESCRIPTION OF THE INVENTION

As inferred from the drawings that accompanies and forms part of this description, the Cell phone device blocking system when used in motor vehicles of any kind (1) is intended for the field of road safety, more specifically for the area of prevention of traffic accidents inhibiting the use of the cell phone device, to make or receive cell phone calls when the vehicle is in motion or it is turned on, thus avoiding that the driver be neglected and may cause an accident, wherein it is constituted by an electro electronic device with sensors and other components which will create an electromagnetic isolation (2) into the vehicle interior (3), more specifically in the cabin, which will isolate either the emitted signals (4), or the received signals (5) by the cell phone device (6).

When in operation, if the driver dials or activates the receiving calls key, the sensors installed on the device will trigger specific components that will create an electromagnetic barrier (2) increasing the signal-to-noise ratio when capturing by means of the sensors the beginning of the use of the cell phone device (6), whenever the motor vehicle (3) is in motion or is turned on, avoiding, this way, making cell phone calls, as well as receiving them. That is, when the motor vehicle is stopped and turned off, the cell phone device can be used normally.

### 8.—CONCLUSION

It is noted for all that have been described and illustrated referring to a Cell phone device blocking system when used in motor vehicles of any kind (1), that this fits perfectly within the rules governing Patent inventions, and that it must fulfill an important gap in the market, therefore concerning all that have been previously described and illustrated, it deserves its respective privilege.

1) “CELL PHONE DEVICE BLOCKING SYSTEM WHEN USED IN MOTOR VEHICLES OF ANY KIND” (1) It is intended for the field of road safety, more specifically for the area of prevention of traffic accidents inhibiting the use of the cell phone device (6), to make or receive cell phone calls, that is, when the motor vehicle is in motion or it is turned on. That is, when the motor vehicle is stopped and turned off, the cell phone device can be used normally, thereby preventing the driver from being neglected and causing an accident, wherein it is constituted by an electro electronic device provided with sensors that will trigger specific components, creating an electromagnetic isolation (2), which will isolate either the emitted (4) or the received signals (5) by the cell phone device (6).
